(19) United States
(12) Patent Application Publication
(10) Pub. No.: US 2009/0179046 A1
(43) Pub. Date: Jul. 16, 2009

(54) PRESSURIZED FLUID DELIVERY SYSTEM WITH FILTER AND ASSOCIATED METHOD

(76) Inventors: Lucas C. Reichert, Pleasant Grove, UT (US); Gabriel G. Reichert, Lehi, UT (US); Toby Hazelbaker, Pleasant Grove, UT (US); Ronald E. Reichert, Pleasant Grove, UT (US)

Correspondence Address: Workman Nydegger;1000 Eagle Gate Tower, 60 East South Temple, Salt Lake City, UT, 84111, US

(21) Appl. No.: 12/270,787

(22) Filed: Nov. 13, 2008

Related U.S. Application Data
(63) Continuation-in-part of application No. 11/497,672, filed on Aug. 1, 2006.
(60) Provisional application No. 60/987,741, filed on Nov. 13, 2007.

(51) Int. Cl. B65D 35/28; A45F 3/16; B67D 5/64; B67D 5/58; A47G 19/22

(52) U.S. Cl. 222/95; 222/175; 224/148.2; 220/703; 222/189.06

(57) ABSTRACT

A pressurizable fluid delivery system for a flexible fluid reservoir includes a pressurizable sleeve disposable about the flexible fluid reservoir. The pressurizable sleeve has a pressure chamber that at least partially surrounds the flexible fluid reservoir when the pressurizable sleeve is disposed about the flexible reservoir. A pressure inducer is operably coupled to an inlet of the pressure chamber to pressurize the pressure chamber. The pressurized pressure chamber presses against the at least partially surrounded flexible fluid reservoir to push fluid in the flexible fluid reservoir toward the outlet. The fluid deliver system also includes a valve operatively coupled to the outlet of the flexible fluid reservoir to selectively release fluid from the flexible fluid reservoir.

### PRIORITY CLAIM

Priority is claimed to U.S. Provisional Patent Application Ser. No. 60/987,741, filed Nov. 13, 2007 entitled “PRESSURIZED FLUID DELIVERY SYSTEM WITH FILTER AND ASSOCIATED METHOD”, which is hereby incorporated herein by reference in its entirety.

This is a continuation-in-part of U.S. patent application Ser. No. 11/497,672 filed on Aug. 1, 2006 entitled “PRESSURIZED FLUID DELIVERY SYSTEM AND METHOD”.

### BACKGROUND

Bicyclists, hikers, runners, walkers and other athletes often use hydration packs to maintain adequate hydration while engaging in their sports. These hydration packs usually have a bag like fluid reservoir, or bladder that is disposed in a pack that can be carried by the user. A long flexible hose can connect to the reservoir and may provide a mouthpiece for the user. The mouthpiece can be carried in the user's mouth to allow the user to draw or suck liquid from the reservoir as desired.

These types of hydration packs can be problematic because they depend on hydrostatic head pressure and suction to move fluid from the flexible container through the tube and mouthpiece. Hydrostatic head pressure is the pressure resulting in the hose from the weight of the liquid in the hydration pack. Often this hydrostatic head pressure is inadequate to move a sufficient amount of fluid to quench the user's thirst. Consequently, these types of hydration packs may also require suction by the user through the mouthpiece to provide adequate flow of fluid to the user. Providing the amount of suction force is difficult, if not impossible, for many users, especially when the user is engaged in a vigorous activity such as cycling, running, or the like.

Another problem of these suction type hydration packs is that the amount of fluid drawn from the reservoir is directly proportional to the amount of sucking force applied. Consequently, a considerable amount of force may be needed to draw a sufficient amount of water to quench a user's thirst and meet the user's hydration needs. This is especially problematic when the user is short of breath because of participating in a strenuous activity.

Some hydration packs have pressurization systems to pressurize the liquid in the reservoir to overcome the sucking force problem. Most of these systems have a second flexible tube coupled between the reservoir and a pressure source, such as a pump. The user can actuate the pump in order to force air, or some other compressible gas into the reservoir, thereby pressurizing the reservoir with the pumped air. The pumped, pressurized air exerts pressure on the liquid and forces the liquid out of the flexible tube when the mouthpiece valve is activated by the user.

Unfortunately, these types of hydration packs work best when the pack is in an upright position since the liquid has to remain near the tube outlet in order to be pushed through the tube by the pressurized air. Moreover, as liquid is consumed, more pressurized air is required to maintain pressure on the liquid. Thus, many pressurization cycles may be needed to maintain enough pressure in the bladder to force the liquid through the tube. Additionally, when the pack nears an empty point, the pressurized air is often insufficient to force the remaining liquid out the tube.

### SUMMARY

The present invention provides a pressurizable fluid delivery system for a flexible fluid reservoir that can selectively dispense a fluid through an outlet of the fluid reservoir. The fluid delivery system can include a pressurizable sleeve disposable about the flexible fluid reservoir. The pressurizable sleeve can have a pressure chamber with an inlet for pressurizing the pressure chamber, and the pressure chamber can at least partially surround the flexible fluid reservoir when the pressurizable sleeve is disposed about the flexible reservoir. The fluid delivery system can also include a pressure inducer that can be operably coupled to the inlet of the pressure chamber to pressurize the pressure chamber. The pressure chamber can be configured to press against the at least partially surrounded flexible fluid reservoir to push fluid in the flexible fluid reservoir toward the outlet. The fluid deliver system can also include a valve operatively coupled to the outlet of the flexible fluid reservoir. The valve can be operated to selectively release fluid from the flexible fluid reservoir. A purification unit may be positioned between the bladder and the valve, and can treat fluid released from the bladder.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a perspective view of a pressurizable fluid delivery system in accordance with an embodiment of the present invention;

FIG. 2 is an exploded, perspective view of the pressurizable fluid delivery system of FIG. 1;

FIGS. 2a-2c illustrates a purification unit disconnected from the fluid delivery system at alternate points of detachment;

FIG. 3 is a cross section of the pressurizable fluid delivery system of FIG. 1, shown with a pressure chamber at least partially surrounding a flexible fluid reservoir;

FIG. 4 is a cross section of the pressurizable fluid delivery system of FIG. 1, shown with a pressure chamber substantially surrounding a flexible fluid reservoir;

FIG. 5 is a cross section of the pressurizable fluid delivery system of FIG. 1, shown with a pressure chamber surrounding a flexible fluid reservoir;

FIG. 6 is a cut-away view of a pressure sleeve of the pressurizable fluid delivery system of FIG. 1;

FIGS. 7a-7d illustrate a method for pressurizing and dispensing liquid from a pressurizable fluid delivery system in accordance with an embodiment of the present invention;

FIG. 8 is a perspective view of a pressurizable fluid delivery system in accordance with another embodiment of the present invention; and

FIG. 9 is a perspective view of a pressurizable fluid delivery system in accordance with another embodiment of the present invention.

### DETAILED DESCRIPTION OF EXEMPLARY EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention. The following detailed description and exemplary embodiments of the invention will be best understood by reference to the accompanying drawings, wherein the elements and features of the invention are designated by numerals throughout.

The present invention is generally directed to a pressurizable fluid delivery system for delivering pressurized and treated fluids to a user. For example, pressurized fluid can be useful in hydrating a person engaging in a strenuous activity, such as cycling, running, hiking, backpacking or the like. Accordingly, the pressurizable fluid delivery system can include a flexible fluid reservoir such as a bladder that can be filled with a liquid such as water, electrolyte replacement fluids, energy drinks, or the like. Pressurized fluid can also be useful in cleaning equipment or gear.

A pressurizable or inflatable sleeve can be disposed about the flexible bladder and can at least partially encompass or surround the flexible bladder. The pressurizable sleeve can have a chamber that can be pressurized. The pressurized chamber can press against the flexible bladder when the sleeve is disposed about the bladder. The force of the chamber pressing against the flexible bladder can push the fluid in the bladder toward an outlet in the flexible bladder. A valve can be operatively coupled to the bladder and can be opened to release fluid from the bladder. The force of the chamber pressing against the bladder can produce a pressurized liquid stream from the opened valve.

A purification unit can be positioned between the bladder and the output valve or bite valve. The purification unit can be configured to treat fluid released from the bladder. As used herein, the terms “treat” and “purify” are interchangeable and refer to the act of killing, destroying, inhibiting growth, or decreasing the activity of microorganisms, including bacteria, viruses, and fungi that are commonly found in fluids such as water. Treatment can also include the removal of unwanted solids or particulate matter from a fluid.

Advantageously, the pressurizable water delivery system of the present invention reduces the need for repressurizing the flexible bladder since the pressure from the pressurizable sleeve can provide an applied force against the flexible bladder even as the bladder is emptied. Additionally, the force applied by the pressurizable sleeve against the flexible bladder can result in a more even pressure on the flexible bladder which results in a more evenly pressurized liquid stream from the opened valve.

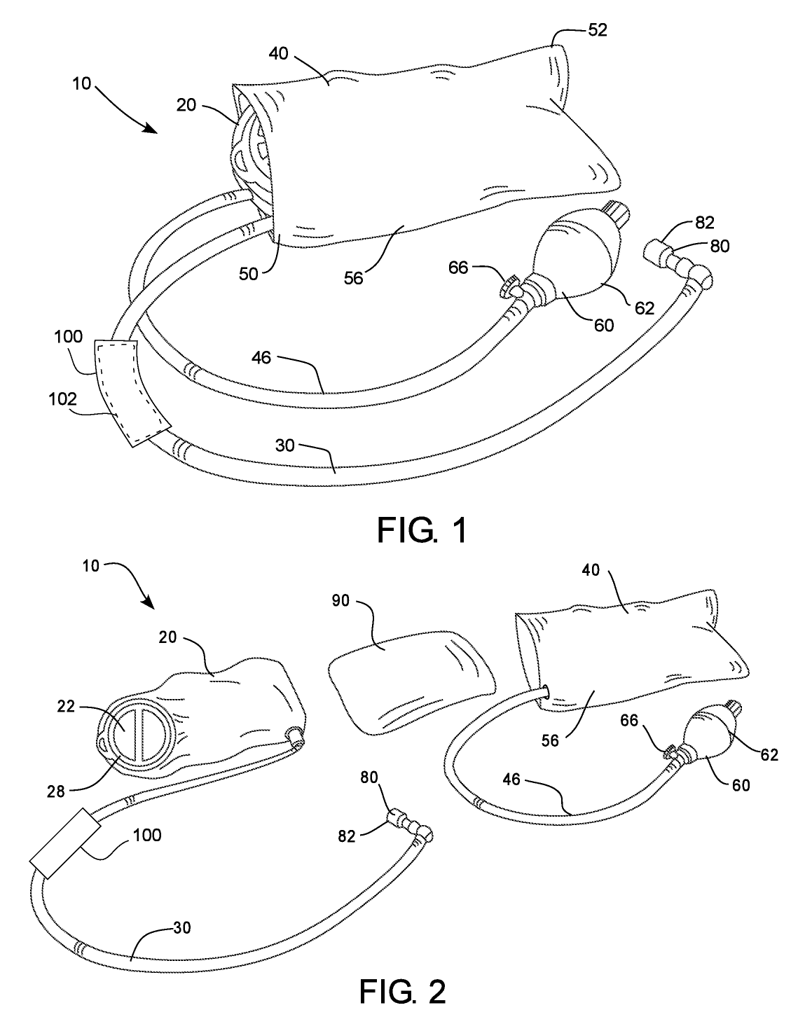

As illustrated in FIG. 1, a pressurizable fluid delivery system, indicated generally at 10, in accordance with an embodiment of the present invention is shown for use in providing a portable, pressurized stream of liquid from a flexible fluid reservoir 20. The flexible fluid reservoir 20 can be filled with a desired liquid, such as water, an electrolyte replacement drink, or the like. In this way, the pressurizable fluid delivery system 10 can be used as a personal hydration device that can be placed in a pack such as a back pack or fanny pack.

The flexible fluid reservoir 20 can also be at least partially surrounded or circumscribed by a removable pressurizable sleeve 40, and a pressure inducer 60, such as a pump, can be operably coupled to the pressurizable sleeve to supply pressure to the sleeve. The pressurizable fluid delivery system 10 can also include a valve 80 that can be operatively coupled to the flexible fluid reservoir 20 to selectively release fluid from the reservoir.

The flexible fluid reservoir 20 can be a bag or bladder type reservoir made from a flexible plastic material suitable for containing liquids fit for human consumption. The flexible bladder 20 can be sized and shaped to fit comfortably within a pack, such as a back pack, fanny pack, or the like. The flexible fluid reservoir 20 can have an inlet 22 and an outlet 26. The inlet 22 can be sized and shaped to allow the flexible fluid reservoir 20 to be filled with the desired liquid and also with a cooling material, such as ice. A lid 28 can close and seal the inlet 22 to restrict leakage of the liquid.

The outlet 26 can be a hole positioned at an opposite end (or another location) of the flexible fluid reservoir 20 from the inlet 22. A flexible tube 30 can be coupled to the outlet 26 and can carry liquid from the reservoir 20 to a desired release location, such as a user's mouth. The valve 80 can close the end of the tube 30 to restrict fluid from leaking from the tube.

A purification unit 100 can be positioned along and/or in-line with the flexible tube 30. According to one embodiment, as shown in FIG. 1, the purification unit can be positioned between the flexible fluid reservoir 20 and the valve 80. In some instances, water collected in the reservoir may be contaminated, and thus dangerous to the health of the person consuming the fluid. This contaminated water may come from contaminated wells, springs, lakes, streams and the like. The purification unit can be configured to treat contaminated fluids, such as water, released from the bladder.

Numerous purification units are known in the art. According to one embodiment, the purification unit 100 can comprise a filter 102, such as a polymer, ceramic or charcoal filter. Charcoal filters are known to be particularly useful for removing bacteria and protozoa, while polymer and ceramic filters can be useful for treating water contaminated with viruses. In another embodiment, the filter can be a reverse osmosis filter. Reverse osmosis is a well-known separation process for treating and purifying water, including seawater. Any combination of the filters described above can also be used.

According to one embodiment wherein reverse osmosis is adopted, the pressure inducer 60 or pump can force the water or other fluid through the filter membrane, which can retain the solute, e.g., impurities, on one side of the filter membrane and allow the pure solvent, e.g., purified water to pass through to the other side of the filter membrane. A variety of reverse osmosis filters and/or filter membranes can be selected for use in connection with the present embodiment depending on the pore size of the membrane and degree of filtration desired.

Although the purification unit 100 and filter 102 can remove microorganisms from the water, in some instances, the purification unit or filter may become contaminated. Accordingly, in one embodiment, the purification unit and/or filter can be removed from the fluid delivery system 10. For example, in one aspect, the purification unit may have a removable cap or door that can be opened to remove the filter. A water tight seal can surround the cap or door to prevent water leakage when in the closed position. Upon removal of the filter, it may be cleansed or sanitized, and reinserted into the purification unit. Alternatively, the filter may be disposed of and replaced with a new filter.

Likewise, the purification unit 100 may be disconnected from the fluid delivery system 10, cleansed or sanitized and reconnected to the system. In some aspects, the housing of the purification unit may be disassembled for cleansing. In still yet another aspect, the purification unit may be disposable. Thus, in the event that it becomes contaminated, it may be disconnected from the system 10, discarded, and replaced with a new unit.

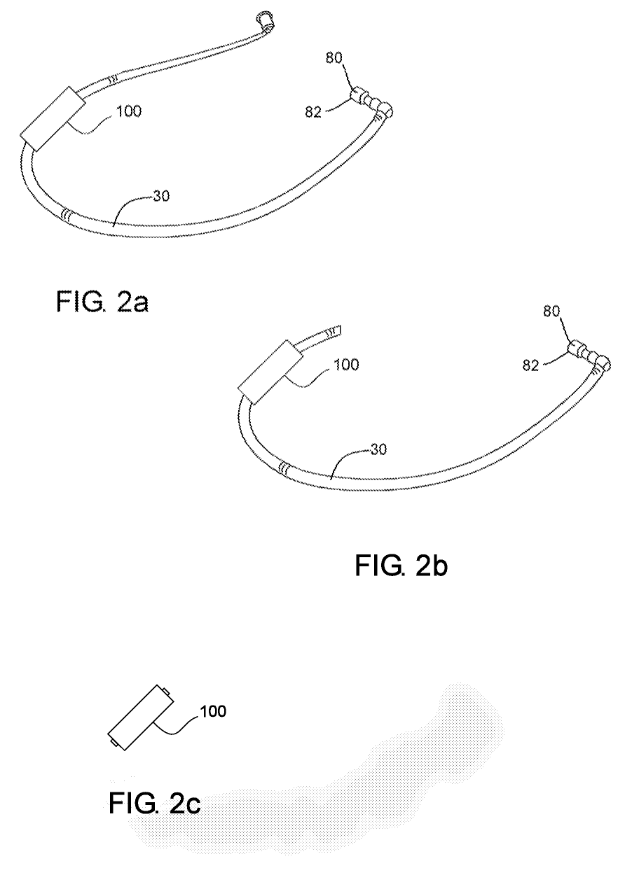

The purification unit may be disconnected at any number of connection points for removal or replacement. A few examples of these connection points are illustrated in FIGS. 2a-2c. For example, substantially all of the line comprising the flexible tube, purification unit, valve and mouth piece may be disconnected from the bladder, as shown in FIG. 2a. Alternatively, only a portion of the flexible tube and purification unit may be removable, as shown in FIG. 2b. And in one aspect, the purification unit may be disconnected from the flexible tube 30 at the points where the tube and purification unit intersect, as illustrated in FIG. 2c. Preferably, the points of connection can have water tight couplings to prevent water leakage from the system regardless of their positioning within the system.

In yet another embodiment, the purification unit 100 or filter 102 can be enhanced by embedded particles for suppressing the growth of pathogens. For example, silver metal nanoparticles have known antimicrobial properties and may be bonded to ceramic elements or charcoal filters to thwart contamination.

In one embodiment, the purification unit can comprise more than one filter. Likewise, the purification unit can treat the water by passing it through a series of stages. For example, a sediment filter or screen may be placed near the entrance of the purification unit. This type of filter can remove sand or other relatively large particles from the water. A second filter, such as a carbon or reverse osmosis filter may also be used to filter out smaller particles and biological organisms.

Other methods and instruments for decontamination may be integrated into various embodiments of the present invention. For example, an ultra-violet light lamp may be placed within the purification unit to disinfect any microbes that successfully pass through the filter. In another aspect, chemicals, such as chlorine or iodine may be place within the purification unit and used to treat water passing through the purification unit.

The purification unit 100 can take on any number of physical embodiments. For example, the purification unit can be cylindrical or rectangular in shape. The purification unit can be configured to attach to or fit within a backpack housing the system 10. For example, the purification unit may be folded into the strap of the backpack housing the system. Alternatively, a pocket can be incorporated into a backpack to hold the purification unit.

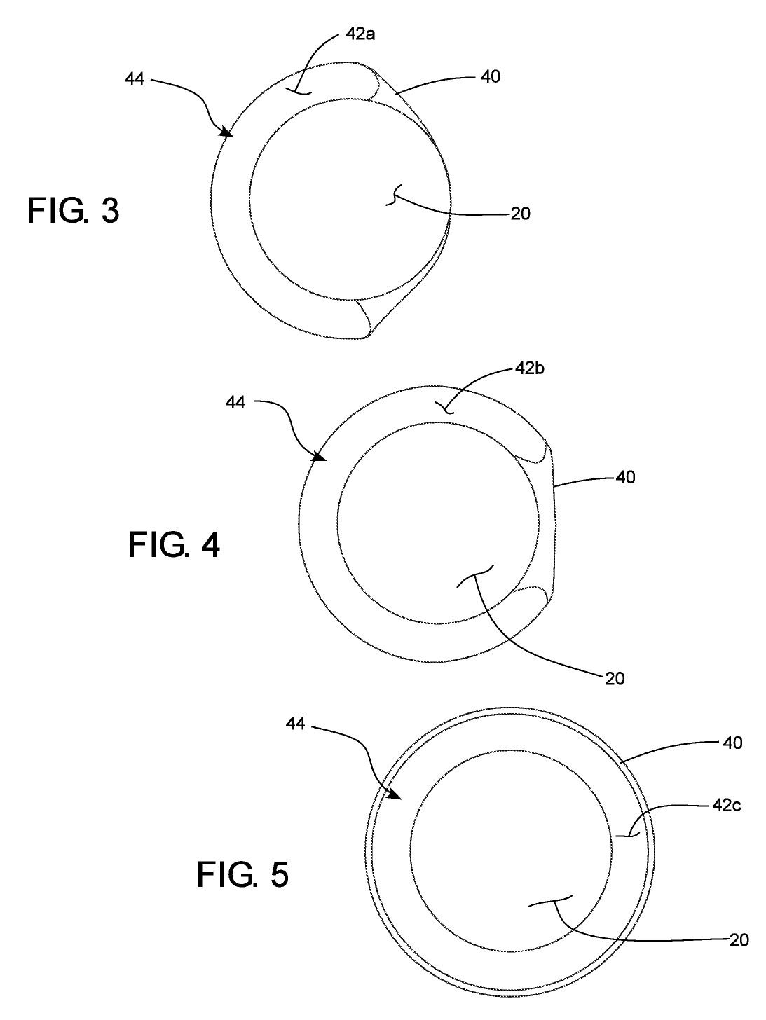

Referring to FIGS. 3-5, a cross section of the pressurizable sleeve 40 surrounding the flexible fluid reservoir 20 is shown. The pressurizable sleeve 40 can be disposable about the flexible fluid reservoir 20, and can include a chamber, indicated generally at 44, that can be pressurized. The pressurizable sleeve 40 can be made of a flexible plastic material similar to the material of the flexible fluid reservoir 20.

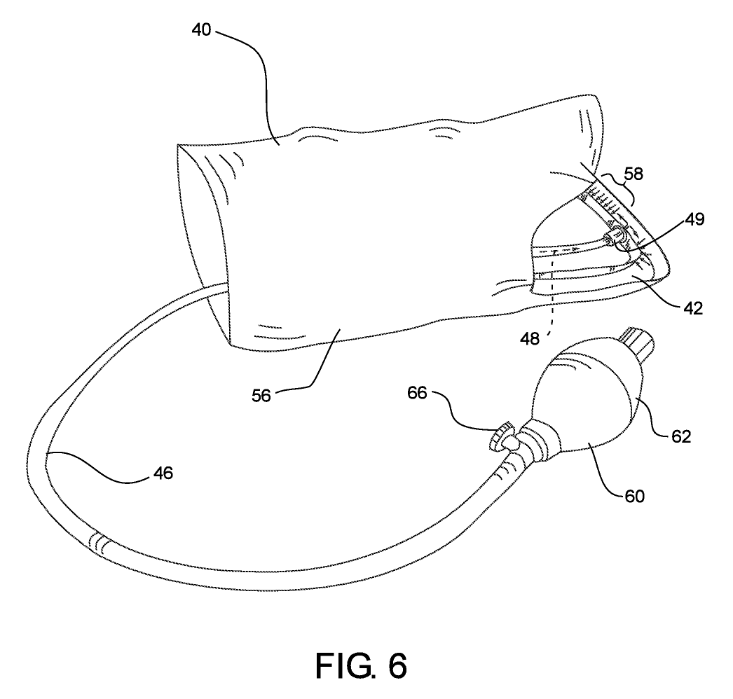

The chamber 44 can include a pressure chamber 42 (FIG. 6) that can at least partially surround or circumscribe the flexible fluid reservoir 20 when the pressurizable sleeve 40 is disposed about the flexible reservoir. For example, as shown in FIG. 3, the pressurizable sleeve 40 can completely circumscribe the flexible fluid reservoir 20, and the pressure chamber 42a can partially surround or enclose the flexible fluid reservoir. Additionally, the pressure chamber 42b can substantially surround or enclose the flexible fluid reservoir 20, as shown in FIG. 4. Furthermore, the pressure chamber 42c can completely circumscribe the flexible fluid reservoir 20, as shown in FIG. 5.

The pressurizable sleeve 40 can be open on a first end 50 and closed on a second end 52 to form a pocket 56, as shown in FIGS. 1-2 and 6. The pocket 56 can be sized and shaped to receive at least a portion of the flexible fluid reservoir 20.

Referring to FIG. 6, the pressure chamber 42 can have an inlet 49 that can be coupled to the pressure inducer 60 to supply pressure to the pressure chamber 42. A flexible tube 46 can be fluidly coupled between the pressure inducer 60 and the pressure chamber. It will be appreciated that the flexible tube 46 can be coupled adjacent the open first end 50 of the pressurizable sleeve 40, or the closed second end 52 of the pressurizable sleeve 40. The flexible tube 46 can transmit a pressure supply from the pressure inducer 60 to the pressure chamber 42.

The pressure inducer 60 can be a source of compressible gas, such as a hand or electric air pump, an air compressor, a blow tube, a carbon-dioxide gas cartridge, a helium tank, or mixtures and combinations of these sources. For example, the pressure inducer 60 can be a manual pump including a compressible bulb 62. A relief valve 66 can be coupled in line between the tube 46 and the compressible bulb 62 to allow release of the pressure in the chamber 20. In use, the compressible bulb 62 can be compressed by the user to pump air through the flexible tube 46, indicated by arrow 48, and into the pressure chamber, as illustrated by arrows shown generally at 58. The air can inflate and pressurize the pressure chamber 42. It will be appreciated that other types of hand pumps, such as bicycle pumps, or piston pumps can also be used, as well as common electrical pumps known in the art.

It will be appreciated that, when pressurized, the pressure chamber 42 can expand to have a larger volume with respect to the pressure chamber 42 in an unpressurized state. Consequently, when the pressurizable sleeve 40 is disposed on the flexible fluid reservoir 20, and the chamber 42 is pressurized, the expanded, pressurized chamber 42 can press against the flexible fluid reservoir 20 and push the liquid in the flexible fluid reservoir toward the outlet 26. In this way, the force of the pressure in the inflated or pressurized chamber 20 can be transferred to the liquid inside the flexible fluid reservoir 20. Advantageously, higher pressure supplied to the pressure chamber 42 results in higher pressure in the liquid in the flexible fluid reservoir 20, and a more forceful release of liquid from the flexible fluid reservoir 20 when the valve 80 is opened.

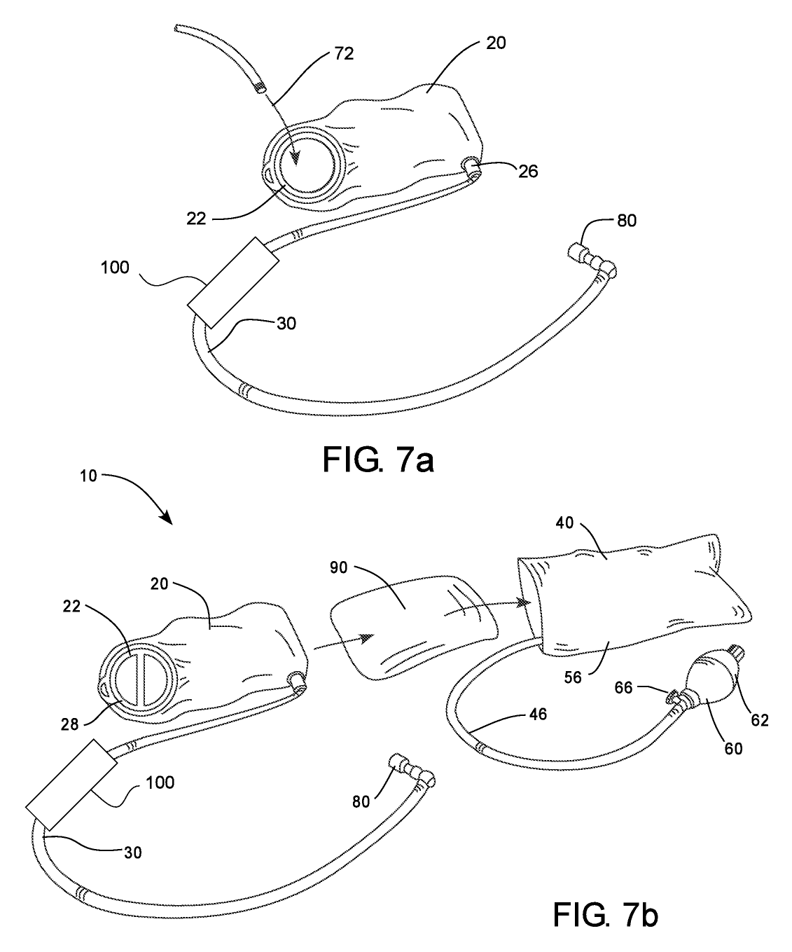

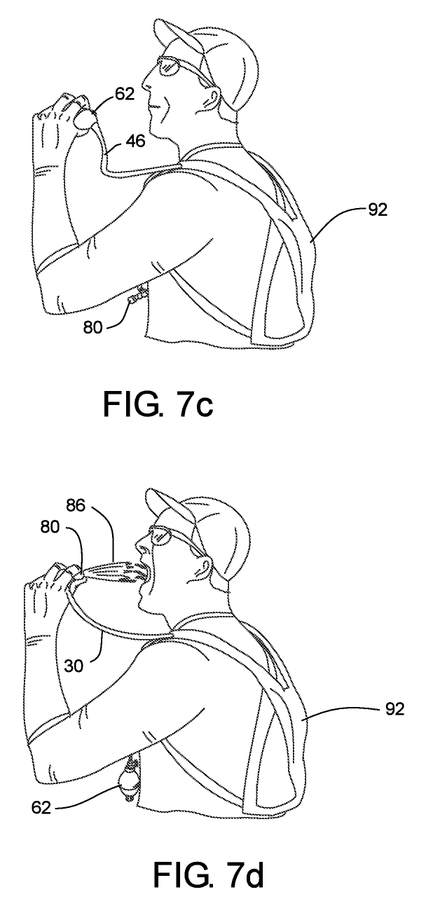

Returning to FIGS. 1-2, the valve 80 can be positioned at an end of the flexible tube 30 so as to be positionable by the user of the pressurizable fluid delivery system 10 in an easily accessible position. The valve 80 can be a standard gate type valve, such as a ball valve, a compression valve, a T valve, or the like. For example, as shown in FIGS. 1-2, the valve 80 can be a compression valve that can be closed in an uncompressed configuration and open in a compressed configuration. The compression valve 80 can include a bite shroud 82 that can be placed between the teeth of the user so that the user can bite on the bite shroud to compress and open the compression valve 80. In this way, the compression valve 80 can be a bite valve or mouth valve that can allow hands free operation. Additionally, the shroud 82 can be compressed between the thumb and fingers of the user to open the compression valve 80, as shown in FIG. 7c. In this way, the user can selectively open the valve 80 to release liquid from the flexible fluid reservoir 20.

Advantageously, as shown in FIG. 7d, the force of the pressure from the chamber 20 can push the liquid in the flexible fluid reservoir 20 through the flexible tube 30 and out the valve 80 with sufficient force so as to create a projecting stream of liquid 86 that can project into the mouth of the user without having the valve 80 directly in the mouth of the user.

Additionally, it is a particular advantage of the present invention that the liquid can be forced by pressure from the tube as a pressurized, projected stream. Such a pressurized stream can be useful in many applications. For example, the projecting stream of liquid 86 can be used to wash and clean dirt and debris from shoes, bicycles, or other equipment employed by the user. The projecting stream of liquid 86 can also be used to create a mist of liquid that can be sprayed onto the user to cool and refresh the user, or a pet, or a partner that is engaged in strenuous activity. The projecting stream of liquid can also be used to fill another container or bowl. Additionally, the projected pressurized stream of liquid can be used to put out a fire, thereby allowing the present invention to be used as a light weight fire extinguisher.

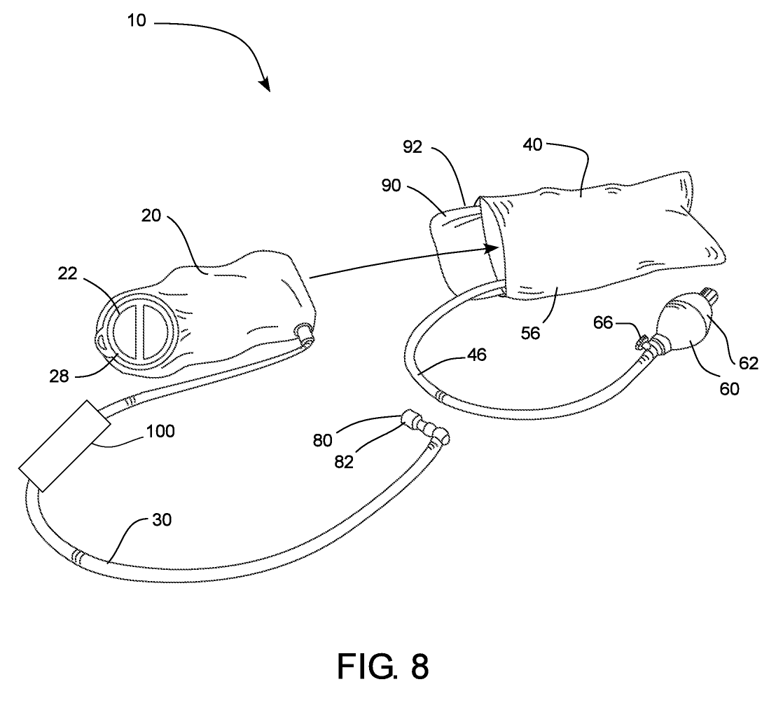

Referring to FIGS. 2 and 8, the pressurizable fluid delivery system 10 can also include a stiffening insert 90 associated with the flexible fluid reservoir 20 and the pressurizable sleeve 40. The stiffening insert can be disposed adjacent the flexible fluid reservoir 20 and the pressurizable sleeve 40. For example, the stiffening insert 90 can be disposed between the flexible fluid reservoir 20 and the pressurizable sleeve 40 as shown in FIG. 2. As another example, the stiffening insert 90 can be disposed adjacent to the pressurizable sleeve 40 as shown in FIG. 8. The stiffening insert 90 can be disposed in a pocket 91 coupled to the pressurizable sleeve.

The stiffening insert 90 can also be sized and shaped to maintain an elongated shape of the pressurizable sleeve 40 as fluid is released from the flexible fluid reservoir 20. The stiffening insert 90 can be made of a stiff plastic material that can provide stiffness without adding significant weight to the pressurizable fluid delivery system 10.

Advantageously, the stiffening insert 90 can provide support to the user carrying the pressurizable fluid delivery system 10 in a pack. For example, the stiffening insert 90 can be bendable and can conform to the approximate shape of the user's back in the case the pressurizable fluid delivery system 10 is contained in a backpack 92, as shown in FIGS. 7c-7d. Additionally, the stiffening insert 90 can provide application of additional pressure to the flexible fluid reservoir 20, thereby increasing the likelihood of releasing substantially all of the liquid from the reservoir if desired.

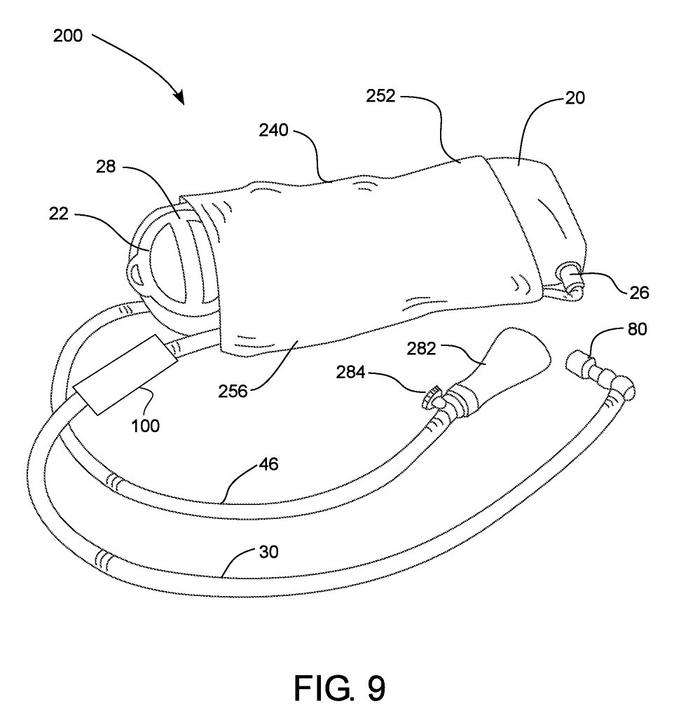

As illustrated in FIG. 9, a pressurizable fluid deliver system, indicated generally at 200, in accordance with another embodiment of the present invention is shown for use in providing a portable, pressurized stream of liquid from a flexible fluid reservoir 20. The pressurizable fluid delivery system 200 is similar in many respects to the pressurizable fluid delivery system 10 described above and shown in FIGS. 1-7d. Additionally the pressurizable fluid delivery system 200 can have a pressurizable sleeve 240 that has an open first end 250 and an open second end 252 to form a tube 256. The flexible fluid reservoir 20 can fit within the tube 256 and the tube can circumscribe the reservoir. Additionally, the pressure inducer can be a compressed gas cartridge 282 that can have a valve 284. The valve 284 can be opened by the user to release a compressed gas, such as carbon-dioxide into a pressure chamber (not shown) that can at least partially surround the flexible fluid reservoir 20.

The present invention also provides for a method for pressurizing a liquid in a flexible fluid reservoir 20 such as a bladder, as illustrated in FIGS. 7a-7d. The method can include filling the flexible bladder 20 with a liquid, as shown by arrow 72 in FIG. 7a. The flexible bladder 20 can be placed inside an inflatable sleeve 40 that can substantially circumscribe the flexible bladder 20, as shown in FIG. 7b. Air can be pumped into the inflatable sleeve with a compressible bulb hand pump 62, as shown in FIG. 7c, in order to inflate the pressurizable sleeve 40 and apply pressure to the flexible bladder 20. A valve 80 coupled to the flexible bladder can be opened to allow the liquid to flow from the flexible bladder 20 and out of the valve 80 in response to the pressure applied to the flexible bladder 20 by the inflated sleeve 40, as shown in FIG. 7d.

The method for pressurizing a liquid in a flexible fluid reservoir can also include placing a support board 90 adjacent the flexible bladder 20 and the inflatable sleeve 40 to provide support for the inflatable sleeve and flexible bladder as liquid is released from the flexible bladder. Additionally, the flow of liquid from the valve 80 can be directed into a user's mouth from a desired distance away from the user's mouth, as shown in FIG. 7d.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A fluid delivery system, comprising:
a flexible bladder having a inlet, and configured to contain liquid;
an inflatable sleeve at least partially surrounding the flexible bladder, and having an inlet;
a pump associated with the inlet of the inflatable sleeve, and configured to inflate the inflatable sleeve;
a valve operatively coupled to an outlet of the flexible bladder, and operable to release the liquid contained in the flexible bladder; and
a purification unit positioned between the bladder and the valve, the purification unit configured to treat fluid released from the bladder.

2. The system of claim 1, wherein the purification unit comprises a filter.

3. The system of claim 2, wherein the filter is disposable.

4. The system of claim 2, wherein the filter is interchangeable.

5. The system of claim 1, wherein the purification unit is disposable.

6. The system of claim 1, further including a stiffening insert associated with the flexible bladder and the inflatable sleeve, and configured to maintain an elongated shape of the inflatable sleeve as fluid is released from the flexible bladder.

7. The system of claim 6, wherein the inflatable sleeve is inflatable with a gas.

8. The system of claim 7, wherein the gas is selected from the group consisting of air, compressed air, carbon-dioxide, compressed carbon dioxide, helium, and mixtures thereof.

9. The system of claim 1, wherein the pump is a manually operated pump to pump air into the pressure chamber.

10. The system of claim 1, wherein the pump includes a compressed gas source configured to release compressed gas into the pressure chamber to inflate the pressure chamber.

11. The system of claim 10, wherein the inflatable sleeve includes a closed end and an open end to form a pocket configured to receive the flexible bladder.

12. The system of claim 1, wherein the valve is a compression valve configured to open under an applied compressive force.

13. The system of claim 12, wherein the valve includes a bite shroud and the compressive force is applied by a user's teeth.

14. A pressurizable fluid delivery system for a flexible fluid reservoir configured to hold and selectively dispense a fluid through an outlet, comprising:
a pressurizable sleeve disposable about the flexible fluid reservoir, and having a pressure chamber with an inlet for pressurizing the pressure chamber, the pressure chamber at least partially surrounding the flexible fluid reservoir when the pressurizable sleeve is disposed about the flexible reservoir;
a pressure inducer operably coupled to the inlet of the pressure chamber, and operable to pressurize the pressure chamber and push fluid in the flexible fluid reservoir toward the outlet;
a valve operatively coupled to the outlet of the flexible fluid reservoir, and operable to selectively release fluid from the flexible fluid reservoir; and
a purification unit configured to treat fluid passing from the fluid reservoir to the valve.

15. The system of claim 14, further including a stiffening insert associated with the flexible fluid reservoir and the pressurizable sleeve, and configured to maintain an elongated shape of the pressurizable sleeve as fluid is released from the flexible fluid reservoir.

16. The system of claim 14, wherein the pressure chamber is inflatable with a compressible gas.

17. The system of claim 14, wherein the pressure inducer includes a pump configured to pump a compressible gas into the pressure chamber to inflate the pressure chamber.

18. The system of claim 14, wherein the pressure inducer includes a compressed gas cartridge configured to release compressed gas into the pressure chamber to inflate the pressure chamber.

19. The system of claim 14, wherein the pressure chamber substantially surrounds the flexible fluid reservoir.

20. The system of claim 14, wherein the pressurizable sleeve includes a closed end and an open end to form a pocket configured to receive the flexible fluid reservoir.

21. A fluid delivery system, comprising:
a flexible bladder having a inlet, and configured to contain liquid;
a inflatable sleeve substantially circumscribing the flexible bladder, and having an inlet;
a pump associated with the inlet of the inflatable sleeve, and configured to inflate the inflatable sleeve;
a valve operatively coupled to an outlet of the flexible bladder, and operable to release the liquid contained in the flexible bladder;
a stiffening insert associated with the flexible bladder and the inflatable sleeve, and configured to maintain an elongated shape of the inflatable sleeve as liquid is released from the flexible bladder; and
a purification unit configured to treat liquid passing from the from the bladder and to the valve.

22. A method of dispensing a pressurized and treated liquid, comprising:
filling a flexible bladder with a liquid;
placing the flexible bladder inside an inflatable sleeve, the inflatable sleeve substantially circumscribing the flexible bladder;
pumping air into the inflatable sleeve to inflate the sleeve and apply pressure to the flexible bladder; and
opening a valve coupled to the flexible bladder to allow the liquid to flow out of the valve in response to the pressure applied to the flexible bladder by the inflated sleeve; and
passing the liquid through a purification unit configured to treat the liquid.

23. The method of claim 22, further comprising:
directing the flow of liquid from the purification unit into a user's mouth.

24. The method of claim 22, further comprising:
placing a stiffening insert adjacent the flexible bladder and the inflatable sleeve to provide support for the inflatable sleeve and flexible bladder as liquid is released from the flexible bladder.
